(19) United States
(12) Patent Application Publication
(10) Pub. No.: US 2011/0051480 A1
(43) Pub. Date: Mar. 3, 2011

(54) 20º PHASE-SHIFTING AUTOTRANSFORMER

(75) Inventor: Francis Blanchery, Lege Cap-Ferret (FR)

(73) Assignee: THALES, Neuilly Sur Seine (FR)

(21) Appl. No.: 12/160,968

(22) PCT Filed: Jan. 16, 2007
(86) PCT No.: PCT/EP2007/050401

§ 371 Date: Nov. 18, 2010

(30) Foreign Application Priority Data
Jan. 16, 2006 (FR) 06/00409

(51) Int. Cl. H02M 5/02

(52) U.S. Cl. 363/154

(57) ABSTRACT

The invention relates to autotransformers used notably for converting alternating (AC) electric power into direct (DC) power. And more precisely, to autotransformers designed to be connected to a three-phase voltage supply of given amplitude supplying three first output voltages (C1, C2, C3) of identical amplitudes, and six other output voltages (A1, A2, A3, B1, B2, B3) of the same amplitude as the first three output voltages and divided into pairs symmetrically phase-shifted by 20° relative to the first three output voltages. According to the invention, the output voltages have greater or lesser amplitudes than the amplitude of the three-phase supply.

The invention relates to autotransformers used notably for converting alternating (AC) electric power into (DC) direct power. Autotransformers may be used to reduce weight and space requirement if there is no requirement for insulation between the potentials on the side of the power supply network and the potentials on the side of use.

AC/DC conversion from a three-phase power supply network voltage uses rectifier bridges; in theory, a single bridge of twice three diodes would be sufficient to rectify three-phase voltage into direct voltage; but in practice the use of a single bridge supplied by the three-phase network produces a direct current affected by too great a residual oscillation, which is unacceptable for many applications. In addition, the rectification causes a reinjection of currents into the network, these currents having harmonic frequencies of the frequency of the power supply alternating current. These reinjections of harmonics are unacceptable if they are too great.

To reduce the direct voltage residual undulations and the harmonics of current reinjected into the network, it has already been proposed to increase the number of phases of the power supply current and the number of rectifier bridges. Therefore, typically, it is possible to transform the three-phase system, whose three phases are spaced at 120°, into a system with nine phases spaced at 40° which may be considered to be a system of three three-phase networks shifted by 40° relative to one another. Three six-diode bridges are used, each bridge being supplied by one of these networks. These eighteen-diode AC/DC converters are also called eighteen-pulse converters. The residual undulations become weak, the reinjections of harmonics also. The nine phases are produced from one autotransformer. Such an achievement is for example described in U.S. Pat. No. 5,124,904. This autotransformer comprises a magnetic core with three branches and a main coil on each magnetic branch. The three main coils are connected in a triangle and it has been noted that a considerable share of the supply power passes through the magnetic circuit of the autotransformer.

In addition, the direct voltage obtained from this nine-phase system is higher than that which would be obtained from three phases, for various reasons, including the fact that the residual undulation is weaker and the direct voltage depends on the average value of the residual undulation. For reasons of equipment compatibility for example (three-phase voltage imposed, direct voltage of use imposed) the user may wish that there is not this change of direct voltage level when six-diode rectification is replaced by eighteen-diode rectification. To prevent finishing up with a direct voltage that is higher than that which would give a simply three-phase rectification (for the same three-phase power supply voltage value) it is then necessary to provide additional voltage-reduction means in the autotransformer. In U.S. Pat. No. 5,124,904, one embodiment provides that these means are constituted by additional windings which increase complexity and weight and the rates of leakage reactants.

U.S. Pat. No. 5,619,407 proposes a different solution to reduce the direct voltage supplied at the output of the rectifier bridges. This solution does not use additional windings, but it is not very satisfactory because it results in a nonsymmetric autotransformer structure; this absence of symmetry leads to a harmonic distortion and therefore a greater reinjection of harmonics to the power supply network; the greater the percentage of voltage reduction (percentage relative to the direct voltage that would supply the simple three-phase rectification), the more significant is this distortion.

In addition, the systems described above do not provide a solution for increasing the direct voltage relative to that which would give simply a six-diode three-phase rectification. There are cases where a user may wish to increase the direct voltage rather than reduce it.

The object of the invention is to alleviate the defects of the systems described above by proposing a nine-phase autotransformer making it possible to choose a desired level of direct voltage (higher or lower than that which a simple three-phase rectification would give), while limiting the weight and space requirement of the autotransformer.

Accordingly, the subject of the invention is an autotransformer designed to be connected to a three-phase voltage supply of given amplitude supplying three first output voltages of identical amplitudes, and six other output voltages of the same amplitude as the first three output voltages and divided into pairs symmetrically phase-shifted by 20° relative to the first three output voltages, characterized in that the output voltages have greater or lesser amplitudes than the amplitude of the three-phase supply.

By phase-shifting six output voltages by only 20° instead of the 40° proposed in the prior art described above, it is possible to reduce the power passing through the magnetic circuit of the autotransformer. At constant power of the autotransformer, it is possible to reduce the weight of the magnetic circuit.

A phase shift of 20° makes it possible to limit the output harmonic distortion of an AC/DC converter using an autotransformer according to the invention. Phase-shifting by 20° means a real phase shift that is able to depart slightly from a nominal value of 20°. It has been shown that the phase shift could lie in a range of 20°+ or −10% while retaining an acceptable distortion value.

Furthermore, the fact that all the output voltages have identical, or of course substantially identical, amplitudes makes it possible to use an autotransformer according to the invention in an AC/DC converter comprising a diode rectifier that is much more simple to use than a controlled rectifier, for example a thyristor-controlled rectifier. Specifically, when the output voltages of the autotransformer are not equal, the use of an uncontrolled rectifier induces a strong harmonic distortion that can be reduced with the aid of a controlled rectifier.

The invention will be better understood and other advantages will appear on reading the detailed description of an embodiment given as an example, the description illustrated by the attached drawing in which:

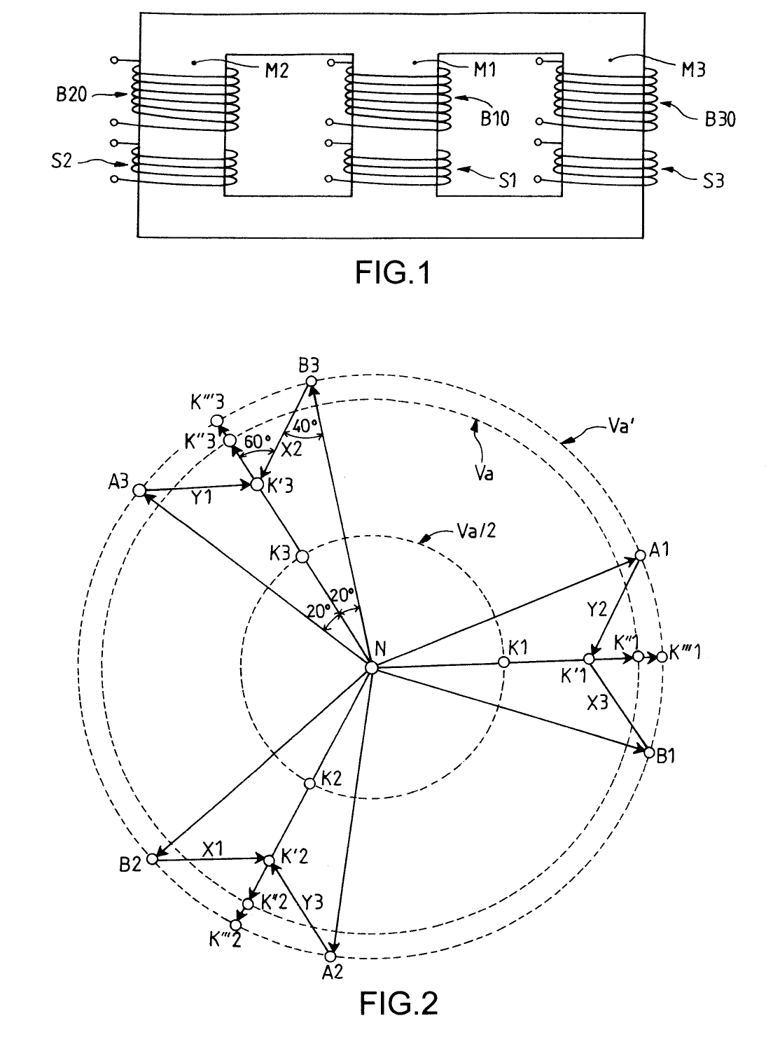

FIG. 1 represents a simplified diagrammatic view of a transformer with three magnetic branches designed for three-phase use;

FIG. 2 represents a vector composition making it possible to define the features of a voltage step-up autotransformer in a first star embodiment according to the invention;

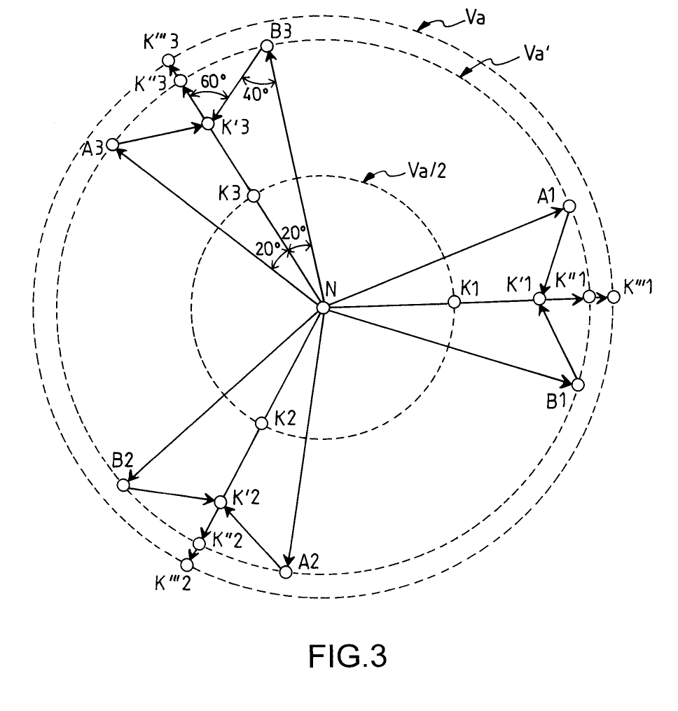

FIG. 3 represents another vector composition making it possible to define the features of a voltage step-down autotransformer, in a second star embodiment according to the invention;

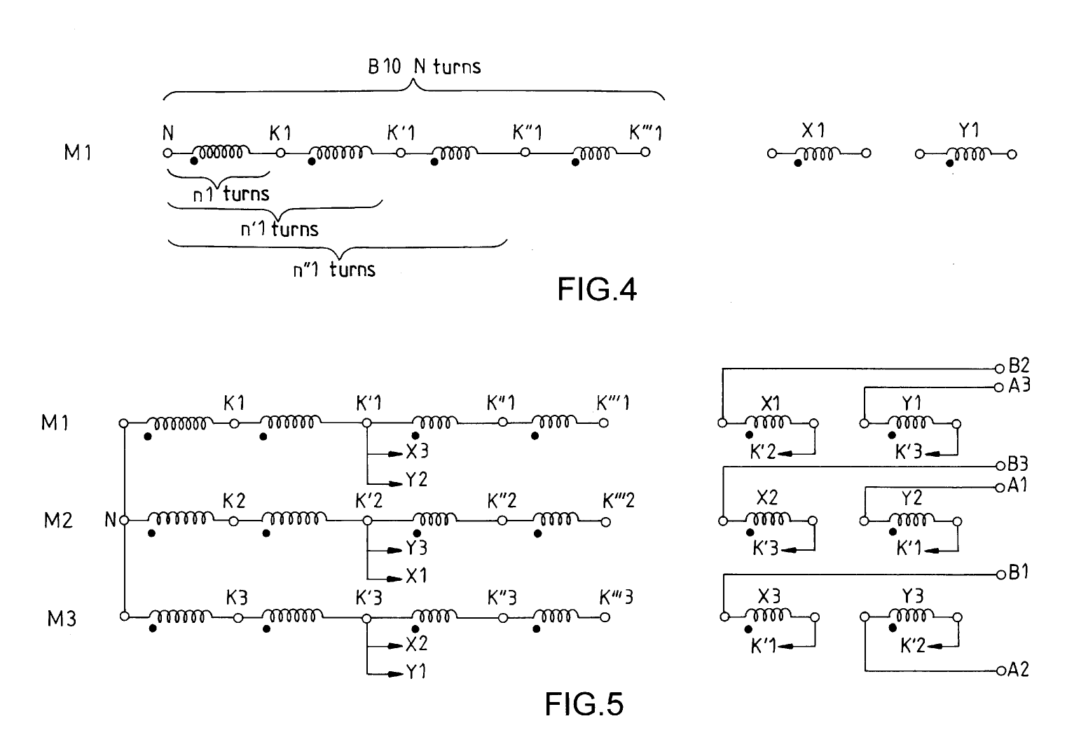

FIG. 4 represents the coils provided on a magnetic branch of the autotransformer of FIG. 2 and FIG. 3;

FIG. 5 represents the installation of the autotransformer making it possible to produce the two vector compositions of FIG. 2 and FIG. 3;

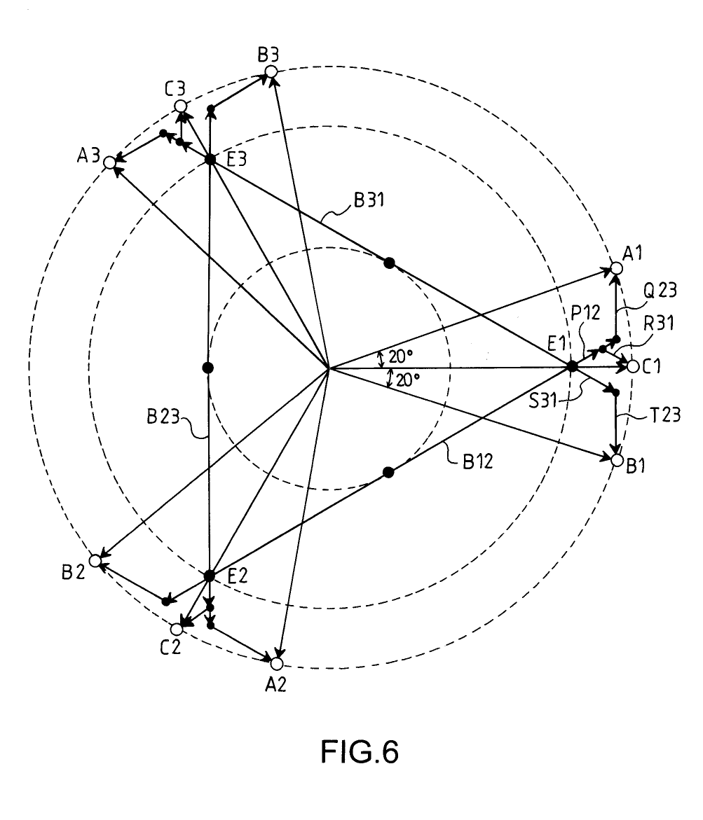

FIG. 6 represents another vector composition making it possible to define the features of a voltage step-up autotransformer, in a first triangle embodiment according to the invention;

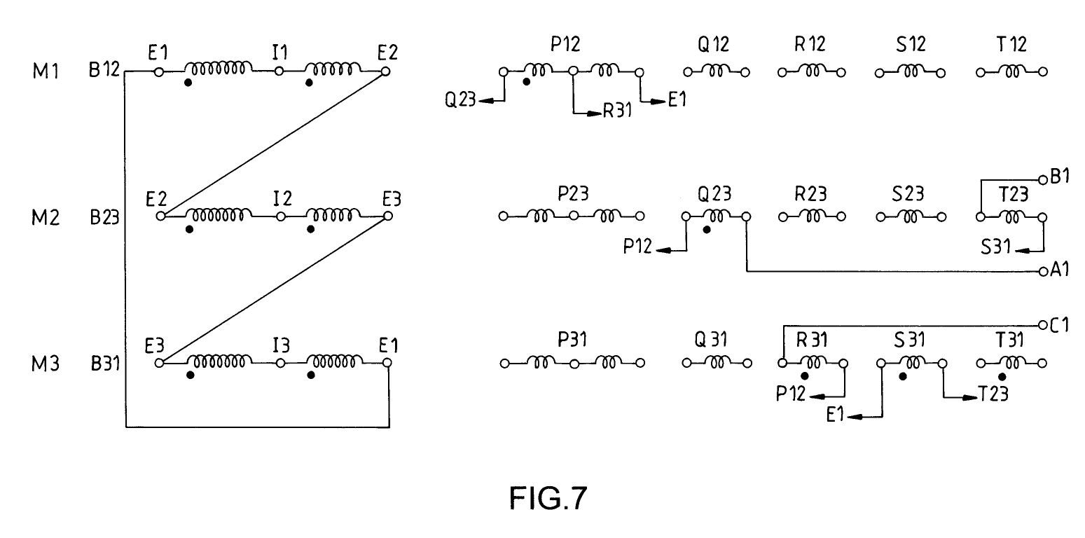

FIG. 7 represents the installation of the autotransformer making it possible to produce the vector composition of FIG. 6;

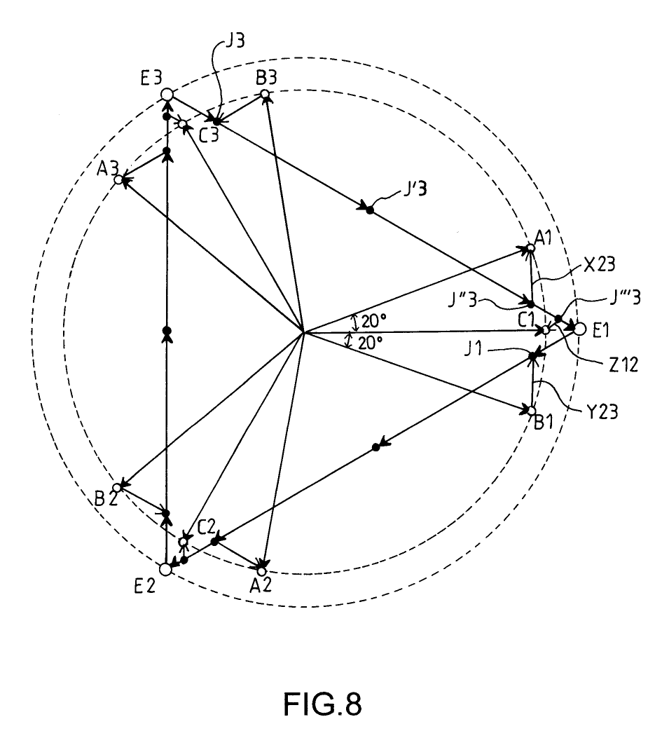

FIG. 8 represents another vector composition making it possible to define the features of a voltage step-down autotransformer, in a second triangle embodiment according to the invention;

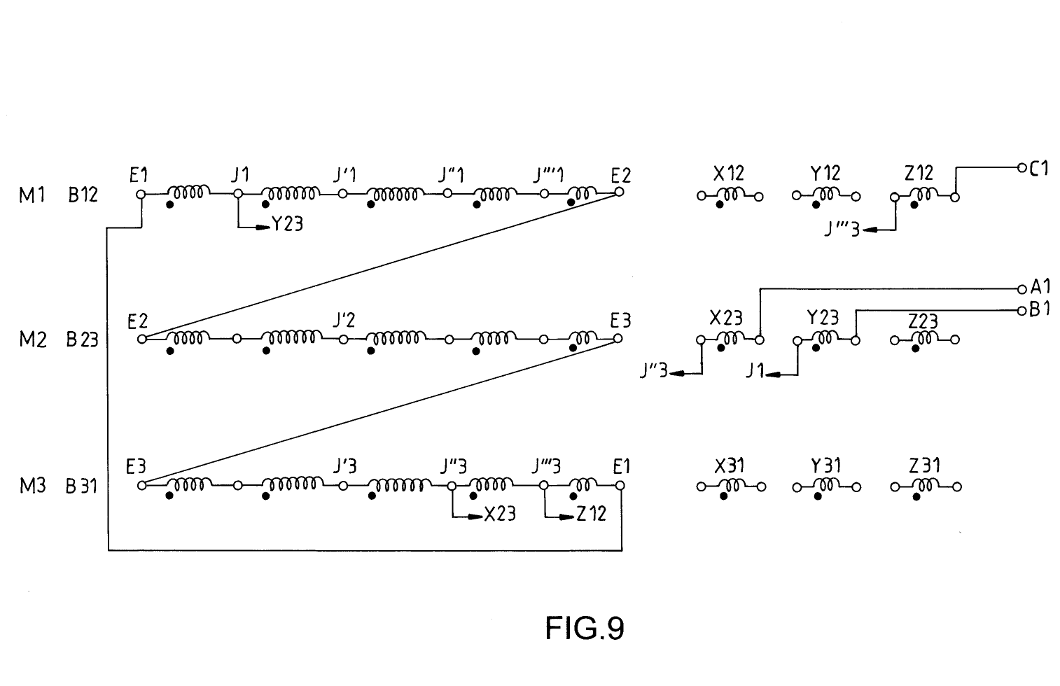

FIG. 9 represents the installation of the autotransformer making it possible to produce the vector composition of FIG. 8;

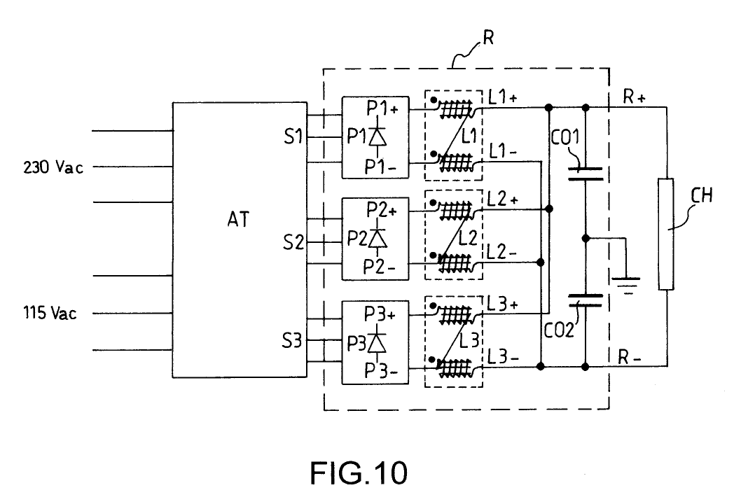

FIG. 10 represents an AC/DC converter using an autotransformer according to the invention.

For the purposes of clarity, the same elements will bear the same reference numbers in the various figures.

A few general principles are given first.

FIG. 1 shows the conventional principle of a three-phase transformer formed by coils placed around branches of a closed triple magnetic circuit. The closed triple magnetic circuit comprises a ferromagnetic core with a central branch M1 to receive the coils corresponding to a first phase, and two lateral branches M2 and M3 connected to the central branch on either side of the latter to receive the coils of a second and a third phase respectively. The central branch M1 and one of the lateral branches form a first closed magnetic circuit; the central branch and the other lateral branch form a second closed magnetic circuit; the two lateral branches M2 and M3 form a third closed magnetic circuit.

Several coils are wound onto each branch, certain of them forming transformer primaries and others forming secondaries. The installation is identical for the three branches, that is to say that the coils playing the same role on the various branches comprise the same number of turns and the same direction of winding.

As a simplified diagram, FIG. 1 shows a respective main coil B10, B20, B30 and a respective auxiliary coil S1, S2, S3 on each branch of the magnetic core. The coils of one and the same magnetic branch are travelled over by the same magnetic flux. For greater convenience of representation, the auxiliary coils are represented beside the main coils although in reality the two coils are placed in the same location (one around the other, or even the layers of one are inserted between the layers of the other) in order to be traversed exactly by the same magnetic flux.

In the simplest connection diagram that can be imagined, transforming one three-phase voltage into another three-phase voltage, the main coils could be the primary windings of a transformer and the auxiliary coils would be secondary coils. The primary coils could be connected in a triangle or in a star, in order to receive the three-phase voltage to be converted. The secondary coils would also be connected either in a triangle or in a star in order to produce a three-phase voltage. The magnetic fluxes that travel in the three branches are identical but phase-shifted by 120° from one another. In the production of a transformer converting a three-phase voltage into a nine-phase voltage, the installation is more complex and uses a larger number of coils as will be seen, but the principle of a magnetic circuit with three symmetrical branches is retained in which the magnetic fluxes of the various branches are phase-shifted by 120° from one another and in which the coils of one and the same branch are all travelled over by the same magnetic flux.

At the terminals of a secondary coil of a magnetic branch there appears a voltage that is in phase with the voltage at the terminals of the primary coil of the same branch. The voltage generated in the secondary coil depends
on the voltage value at the terminals of the associated primary,
on the ratio between the numbers of turns of the primary and of the secondary,
and on the direction of rotation of the current in the winding of the secondary coil relative to the direction of the current in the primary coil (the voltage phase is inverted if the directions are inverted).

For a transformer with insulation between potentials of the primary and potentials of the secondary, the terminals of the secondary coils are not connected to the terminals of the primary coils or to other circuit elements on the primary side. For an autotransformer (a transformer with no insulation), the terminals of the secondary coils may be connected to the terminals of the primary coils or to intermediate power outlets formed in the primary coils. The invention relates to autotransformers.

The principle of vector representation will now be described making it possible to describe the operation of a more complex transformer and notably an autotransformer capable of supplying nine secondary phases from the three phases of the primary power supply.

The phase and amplitude of the voltage (simple voltage present at a point of the circuit or differential voltage present between two points of the circuit) may be represented by a vector whose length represents the amplitude of the alternating (simple or differential) voltage and whose orientation represents the phase from 0° to 360° of this alternating voltage.

For the constitution of an autotransformer capable of producing nine phases from three phases spaced at 120°, the user looks for vector compositions which, from the initial three phases, make it possible to produce the nine phases sought.

The vectors used in this composition are obtained on the one hand from points representing the terminals of main or auxiliary coils and, on the other hand, from points representing intermediate power outlets of these coils. The voltage obtained between two intermediate power outlets of a main coil is in phase with the voltage of the main coil (the vectors are therefore collinear); its amplitude is a fraction of the voltage at the terminals of the main coil, this fraction being a function of the ratio between the number of winding turns situated between the intermediate power outlets and the total number of turns of the main coil; the relative length of the vector representing the voltage between two intermediate power outlets of a coil is determined by this ratio of number of turns.

According to the same principle, the voltage obtained at the terminals of an auxiliary coil associated with the main coil (that is to say travelled over by the same magnetic flux, so wound at the same location on one and the same magnetic branch) is in phase with the voltage at the terminals of the main coil (the vectors are therefore parallel) and its amplitude is also determined by the ratio between the number of turns of the auxiliary coil and the number of turns of the main coil; the length of the vector representing the voltage in the auxiliary coil is therefore, relative to the length of the vector representing the voltage in the main coil, in the ratio of the numbers of turns.

In this patent application, the term “main coil” will be used to designate a coil having two ends and intermediate power outlets, this term nevertheless not meaning that the main coil is necessarily a primary coil of the autotransformer. Specifically, in certain embodiments (voltage step-down transformer), the main coil will effectively be a primary coil in the sense that it is supplied directly by a voltage to be converted; but in other embodiments (step-up transformer), the main coil will not be a primary coil because the three-phase supply to be converted will not be applied between the two ends of this coil.

FIG. 2 represents a vector composition which makes it possible to lead to the present invention, in the case of a voltage step-up autotransformer. The autotransformer comprises three main coils B10, B20, B30 connected in a star installation. The three main coils B10, B20, B30 have a common terminal N forming the neutral of the autotransformer. The three-phase supply of the autotransformer is applied to three input points K″1, K″2, K″3 each belonging to one of the three main coils, respectively B10, B20, B30.

For convenience, in the following, the same letters (for example K″1, K″2, K″3) will designate both the terminals of a coil (in the figures representing coils), the ends of the vector representing the voltage at the terminals of this coil (in the figures representing the vector compositions) or else the voltage present between this terminal and a point situated at the origin of the corresponding vector diagram.

The three-phase supply comes from an alternating current power distribution network at a frequency that depends on the applications. In aviation, where the invention is of particular value because the requirements of weight, space requirement and suppression of harmonics are strong, the frequency is often 400 Hz and it may also be 800 Hz.

For the vector composition, the point N is chosen as the origin. The simple input and output voltages of the autotransformer will be referenced relative to this point. So, the vector NK″1 represents the amplitude and the phase of the simple voltage present on the terminal K″1 of the three-phase supply. If it is supposed that the three-phase supply applied at K″1, K″2 and K″3 is well balanced, the neutral point N represents the point of reference at which the vector sum of the voltages NK″1, NK″2, NK″3 is zero. The vectors NK″2 and NK″3, of the same amplitude as the vector NK″1, are respectively oriented at +120° and −120° from the reference vector NK″1. To simplify the vector notation, in all that follows the first letter of a vector is considered to be the origin of the vector and the second letter is the end of the vector; therefore, NK″1 represents the vector leaving N and going to K″1 and not the reverse.

In FIG. 2, the chosen phase reference is the phase of the simple voltage NK″1 (horizontal direction). The angles are measured in the clockwise direction. The direction of the vector NK″2 is at +120° and that of the vector NK″3 is at +240°. The other vector compositions use the same conventions of representation.

FIG. 4 represents the coils provided on the magnetic branch M1 of the autotransformer. The coils of the other two branches M2 and M3 are similar and are deduced by replacing the reference numbers 1 by 2 or 3 depending on the branch.

FIG. 5 represents the installation of the autotransformer that makes it possible to produce the two vector compositions of FIG. 2 and FIG. 3.

Each of the main coils B10, B20 and B30 comprises a first and a second terminal. The first terminals are connected at N. The second terminals are called respectively K′″1, K′″2 and K′″3. Each main coil B10, B20 and B30 comprises three intermediate power outlets K1, K′1 and K″1 for the coil B10, K2, K′2 and K″2 for the coil B20 and K3, K′3 and K′3 for the coil B30. In the embodiment represented in FIG. 2 (voltage step-up), the three three-phase input voltages are applied to the power outlets K″1, K″2 and K″3. The first three output voltages are in phase with the three-phase input voltages and are available at the second terminals K′″1, K′″2 and K′″3 of the main coils B10, B20 and B30. A coefficient k represents the ratio between the amplitude Va′ of the voltage of the nine output phases and the amplitude Va of the three three-phase input voltages

Va′=Va×k

The intermediate power outlets K1, K2 and K3 may be used to apply three-phase input voltages that differ from those provided on the power outlets K″1, K″2 and K″3. This arrangement is of value for example in the aviation sector.

In large-sized aircraft such as aircraft for carrying tens or hundreds of passengers, the electric power supply becomes a very important element in the general design of the craft. Specifically, the electric apparatus placed onboard and used either for the operation of the craft or for the onboard services are increasingly numerous and consuming more and more energy.

This energy is generated by alternators coupled to the engines of the aircraft and the alternators usually supply a three-phase voltage of 115 effective volts between neutral and phase, at a frequency of 400 Hz. This voltage is transported inside the aircraft by electric cables whose section is proportional to the square of the value of the current that must be able to be transported by these cables. Typically, it may be necessary to have several hundred meters of cables capable of transporting several kilowatts. The result of this is a considerable weight of copper or aluminum to be installed in the aircraft.

Consequently, it appeared that it could be preferable to now design aircraft in which the transported energy travels at 230 volts at least, in order to substantially divide by 4 the section of the cables transporting the energy. The alternators of such aircraft will therefore be designed to directly supply a three-phase power supply from 400 Hz to 800 Hz and 230 effective volts between neutral and phase. In addition, these modern aircraft will now be fitted with a DC electric power distribution network, typically at 540 volts (plus or minus 270 volts relative to the metal structure of the aircraft). The value of DC energy distribution is to make it possible, by means of variable-frequency inverters, to achieve an individual control of speed of certain synchronous or asynchronous motors present in the craft (compressors, air conditioners, fuel pumps etc.).

Furthermore, the aircraft must consume electric power when they are immobilized on the ground at an airport, with the engines stopped. This power is necessary for performing functions of lighting, air conditioning, maintenance, startup, etc.

They are therefore connected by means of a three-phase connector that can be accessed from outside the aircraft to electric power generator sets placed on the ground, administered by the airports. The generator sets supply all the three-phase power at 115 effective volts since most of the aircraft are fitted out to operate with 115 effective volts. It is possible to imagine that, in the future, the airports are provided with generator sets supplying 115 volts and 230 volts or that special generator sets supplying 230 volts are provided for the case in which an aircraft fitted with 230 volts should land. But this involves a cost that the airports do not wish to bear and this solution can be envisaged only in the very long term when the number of aircraft fitted with 230 volts is very significant.

In the immediate future, the solution is to provide on the aircraft a three-phase transformer placed between an outside power supply connector (designed to be connected to the generator on the ground) and the aircraft's 230 volt power supply network. This transformer adds additional weight and space requirement only for this airport logistics reason.

To remedy this problem, an autotransformer according to the invention may be supplied either at 115 V by the power outlets K1, K2 and K3 or at 230 V by the power outlets K″1, K″2 and K″3.

The other six output voltages are divided into pairs symmetrically phase-shifted by 20° relative to the first three output voltages. In order to produce them, the autotransformer comprises on each magnetic branch M1, M2 and M3 two auxiliary coils X1 and Y1 for the branch M1, X2 and Y2 for the branch M2 and X3 and Y3 for the branch M3. The first output voltage A1 is phase-shifted by −20° relative to the voltage K′″1 and is obtained in the following manner: a first terminal of the auxiliary coil Y2 is connected to the power outlet K′1 and the second terminal of the auxiliary coil Y2 forms the point A1. Similarly, the second output voltage B1 is phase-shifted by +20° relative to the voltage K′″1 and is obtained by connecting a first terminal of the auxiliary coil X3 to the power outlet K′1. The second terminal of the auxiliary coil Y2 forms the point B1.

A similar arrangement is made to obtain the last output voltages. The voltages A2 and B2 are phase-shifted respectively by −20° and +20° relative to the voltage K′″2 and the voltages A3 and B3 are phase-shifted respectively by −20° and +20° relative to the voltage K′″3. The voltage A2 is obtained by connecting a first terminal of the auxiliary coil Y3 to the power outlet K′2. The second terminal of the auxiliary coil Y3 forms the point A2. The voltage B2 is obtained by connecting a first terminal of the auxiliary coil X1 to the power outlet K′2. The second terminal of the auxiliary coil X1 forms the point B2. The voltage A3 is obtained by connecting a first terminal of the auxiliary coil Y1 to the power outlet K′3. The second terminal of the auxiliary coil Y3 forms the point A3. The voltage B3 is obtained by connecting a first terminal of the auxiliary coil X2 to the power outlet K′3. The second terminal of the auxiliary coil X2 forms the point B3.

The lengths of the vectors represented in FIG. 2 make it possible to define the number of turns of the various coils. First of all for the main coil B10, the ratio k between the amplitudes of the input voltage Va and output voltage Va′ makes it possible to define the ratio between the total number N of turns of the winding B10 and the number of turns n″1 between the points N and k″1:

N=n″1×k

The number of turns n1 between the points N and K1 is defined in the same manner. For example, if the autotransformer is supplied either at 230 V by the power outlets K″1, K″2 and K″3 or at 115 V by the power outlets K1, K2 and K3, this gives:

N=n1×2k

The numbers of turns n′1 between the terminal N and the power outlet K′1 and the number of turns of the auxiliary coils may be defined by geometric construction in FIG. 2 or else by trigonometric computation.

In order to ensure the symmetry of the autotransformer, the numbers of turns of the other main coils B20 and B30 are defined in the same manner by changing the reference numbers 1 with 2 or 3 in the preceding determinations. For the same reason, the auxiliary coils all have the same number of turns. The symmetry of the autotransformer makes it possible to provide its reversibility and makes it possible to introduce no phase shift between the current and the voltage on the supply.

The direction of winding of the various coils on their respective magnetic core is given by the orientation of the vectors represented in FIG. 2 or else by the points represented in FIG. 5 in the vicinity of the first turn of each coil; as a reminder, for the main coils, the points indicating the first turns have been represented for each intermediate power outlet. This convention is also used for the other vector compositions and all the figures representing the installation of autotransformers.

FIG. 3 represents another vector composition making it possible to define the features of a voltage step-down autotransformer whose main coils B10, B20 and B30 are connected in a star. Unlike the embodiment represented in FIG. 2, the three-phase supply voltages are applied between the terminals K′″1, K′″2 and K′″3 of the three main coils. The first three output voltages in phase with the input voltages are collected at the points K″1, K″2 and K″3. It is always possible to provide two possibilities for supplying the autotransformer, either by the terminals K′″1, K′″2 and K′″3, or by the intermediate power outlets K1, K2 and K3. The rest of the vector construction of FIG. 3 is achieved by retaining the same modulus for the various vectors representing the output voltages K″1, K″2, K″3, A1, B1, A2, B2, A3 and C3. The numbers of turns are computed and the direction of winding of the coils is determined by analogy with what has been presented in the embodiment shown in FIG. 2.

FIG. 6 represents another vector composition making it possible to define the features of a voltage step-up autotransformer. The connection of the coils necessary to produce this vector composition is represented in FIG. 7. The autotransformer comprises three main coils B12, B23 and B31 connected in a triangle and each wound on one magnetic branch, respectively M1, M2 and M3. The terminals situated at the ends of the coil B12 bear the reference numbers E1 and E2. Similarly, the terminals situated at the ends of the coil B23 bear the reference numbers E2 and E3 and finally the terminals situated at the ends of the coil B31 bear the reference numbers E3 and E1. The three-phase input power supply voltage may be applied either between the terminals E1, E2 and E3 or between the points I1, I2 and I3 forming the intermediate power outlets respectively of the coils B12, B23 and B31. For one and the same output voltage amplitude of the autotransformer, the input voltage applied between the points E1, E2 and E3 will be double that applied between the points I1, I2 and I3.

The autotransformer comprises on each magnetic branch M1, M2 and M3 five auxiliary coils P12, Q12, R12, S12 and T12 for the branch M1, P23, Q23, R23, S23 and T23 for the branch M2 and P31, Q31, R31, S31 and T31 for the branch M3.

An output voltage C1 is obtained in the following manner: a first terminal of the coil P12 is connected to the terminal E1 and an intermediate point of the coil P12 is connected to a first terminal of the coil R31. The second terminal of the coil R31 forms the point C1.

The other six output voltages are divided by pairs symmetrically phase-shifted by 20° relative to the first three output voltages C1, C2 and C3. The first output voltage A1 is phase-shifted by −20° relative to the voltage C1 and is obtained in the following manner: a first terminal of the auxiliary coil P12 is connected to the terminal E1 and the second terminal of the auxiliary coil P12 is connected to a first terminal of the coil Q23. The second terminal of the coil Q23 forms the point A1.

Similarly, the second output voltage B1 is phase-shifted by +20° relative to the voltage C1 and is obtained by connecting a first terminal of the auxiliary coil S31 to the terminal E1. The second terminal of the auxiliary coil S31 is connected to a first terminal of the coil T23. The second terminal of the coil T23 forms the point B1.

So as not to overload FIG. 6, only the connections necessary to obtain the voltages A1, B1 and C1 have been represented. The connections necessary to obtain the other voltages may be deduced by circular permutation.

FIG. 8 represents another vector composition making it possible to define the features of a voltage step-down autotransformer. The connection of the coils necessary to produce this vector composition is represented in FIG. 9. The autotransformer comprises three main coils B12, B23 and B31 connected in a triangle and each wound on one magnetic branch, respectively M1, M2 and M3. The terminals situated at the ends of the coil B12 bear the reference numbers E1 and E2. Similarly, the terminals situated at the ends of the coil B23 bear the reference numbers E2 and E3 and finally the terminals situated at the ends of the coil B31 bear the reference numbers E3 and E1. The coil B12 comprises intermediate power outlets J1, J′1, J″1 and J′″1. Similarly, the coil B23 comprises intermediate power outlets J2, J′2, J″2 and J′″2. Finally the coil B31 comprises intermediate power outlets J3, J′3, J″3 and J′″3. The three-phase input power supply voltage may be applied either between the terminals E1, E2 and E3 or between the points J′1, J′2 and J′3. For one and the same output voltage amplitude of the autotransformer, the input voltage applied between the points E1, E2 and E3 will be double that applied between the points J′1, J′2 and J′3.

The autotransformer comprises, on each magnetic branch M1, M2 and M3, three auxiliary coils X12, Y12 and Z12 for the branch M1, X23, Y23 and Z23 for the branch M2 and X31, Y31 and Z31 for the branch M3.

An output voltage C1 is obtained in the following manner: a first terminal of the coil Z12 is connected to the point J′″3. The second terminal of the coil Z12 forms the point C1.

The other six output voltages are divided by pairs symmetrically phase-shifted by 20° relative to the first three output voltages C1, C2 and C3. The first output voltage A1 is phase-shifted by −20° relative to the voltage C1 and is obtained in the following manner: a first terminal of the auxiliary coil X23 is connected to the point J″3. The second terminal of the coil X23 forms the point A1.

Similarly, the second output voltage B1 is phase-shifted by +20° relative to the voltage C1 and is obtained by connecting a first terminal of the auxiliary coil Y23 to the point J1. The second terminal of the coil Y23 forms the point B1.

Whether the autotransformer is a voltage step-up or voltage step-down autotransformer, it may be used directly to produce an AC/DC voltage converter.

For this, as represented in FIG. 10, the three-phase power supply is connected to the inputs of an autotransformer AT and the outputs are connected to a three times six-diode triple-bridge rectifier. For greater convenience, the inputs are marked E1, E2 and E3 and for the star installations, the outputs in phase with the input voltages: C1, C2 and C3.

The autotransformer AT delivers three three-phase systems S1, S2 and S3. Each system comprises three phases phase-shifted by 120° from one another. The device by rights comprises on each system a rectifier bridge, respectively P1, P2 and P3, and smoothing means, respectively L1, L2 and L3. The rectifier bridge P1, P2 and P3 and the smoothing means L1, L2 and L3 form rectifier means R of the device.

For each system S1, S2 or S3, the smoothing means L1, L2 or L3 comprise a positive output, respectively L1+, L2+ and L3+ and a negative output, respectively L1−, L2− and L3−. The positive outputs L1+, L2+ and L3+ of each of the smoothing means are connected to one another to form a positive output R+ of the rectifier means. The negative outputs L1−, L2− and L3− of each of the smoothing means are connected together to form a negative output R− of the rectifier means. Between the outputs R+ and R− two capacitors Co1 and Co2 are connected in series. The common point of the two capacitors Co1 and Co2 is connected to a ground of the device. The smoothing means L1, L2 and L3 associated with the capacitors Co1 and Co2 make it possible mainly to limit the common mode voltage, and equally the differential mode voltage between the two outputs R+ and R−. The device is designed to supply a load Ch connected between the outputs R+ and R−.

Advantageously, the smoothing means L1, L2 and L3 each comprise two coils coupled to a single magnetic circuit respectively M1, M2 and M3. It is well understood that the magnetic circuits M1, M2 and M3 are independent of one another. The coils bear the reference numbers L11 and L12 for the smoothing means L1, L21 and L22 for the smoothing means L2 and finally L31 and L32 for the smoothing means L3. The two coils L11 and L12 of the smoothing means L1 are represented as an example in FIG. 2. The smoothing means L1, L2 and L3 are independent of one another. Therefore, only the current specific to each rectifier bridge P1, P2 or P3 passes through each of the smoothing means L1, L2 or L3. The current flowing in each coil, for example L11 and L12 of one and the same smoothing means is equal and saturation is not reached. This arrangement makes it possible to reduce the weight of the magnetic circuits M1, M2 and M3. On each magnetic circuit, for example M1, the direction of winding of each coil L11 and L12 is defined so as to cancel out the amps per turn of the two coils. In FIG. 1, the direction of winding is symbolized by dots represented in the vicinity of the first turn of each coil and by a Z shape of each magnetic circuit. In other words, the two coils of each smoothing means are connected in common mode. The smoothing means mainly filter only the common mode voltage. The choke value of the smoothing means is reduced and the filtering of the differential mode voltage is provided by the leakage choke of the smoothing means. The smoothing means is defined so as to obtain a sufficient leakage choke value.

Advantageously, for each system S1, S2 and S3, the associated rectifier bridge, respectively P1, P2 and P3, comprises a positive output respectively P1+, P2+ and P3+, and a negative output respectively P1−, P2−, P3−. For each rectifier bridge, the positive output is connected to a positive input of the smoothing means. Similarly, for each rectifier bridge, the negative output is connected to a negative input of the smoothing means.

Advantageously, the positive input of the smoothing means L1, L2 and L3 is formed by a first terminal of the first coil respectively L11, L21, L31, and the negative input of the smoothing means is formed by a first terminal of the second coil respectively L12, L22, L32. A second terminal of the first coil forms the positive output respectively L1+, L2+ and L3+ of the smoothing means L1, L2 and L3 and a second terminal of the second coil forms the negative output respectively L1−, L2− and L3− of the smoothing means L1, L2 and L3.

1. An autotransformer for connection to a three-phase voltage supply of given amplitude supplying three first output voltages (C1, C2, C3) of identical amplitudes, and six other output voltages (A1, A2, A3, B1, B2, B3) of the same amplitude as the first three output voltages and divided into pairs symmetrically phase-shifted by 20° relative to the first three output voltages, wherein the output voltages have greater or lesser amplitudes than the amplitude of the three-phase supply.

2. The autotransformer as claimed in claim 1, wherein the autotransformer comprises a magnetic core with three branches (M1, M2, M3) and on each magnetic branch a main coil (B10) having a first terminal (N) and a second (K′″1) terminal, the three main coils (B10, B20, B30) being electrically connected together at their first terminal (N) in a star installation, in that the first three output voltages are in phase with the three-phase input voltages, in that it also comprises, on each magnetic branch (M1), two auxiliary coils (X1, Y1), in that, for each branch, the main coil (B10) of a first given branch (M1) having between its first terminal (N) and its second terminal (K′″1), a first intermediate power outlet (K′1) and a second intermediate power outlet (K″1), the first auxiliary coil (X3) of a third given branch (M3) having a first terminal connected respectively to the first intermediate power outlet (K′1) of the main coil (B10) of the first given branch and a second input or output terminal (B1) having a voltage phase-shifted by +20° with the voltage present on the second terminal (K′″1) of the main coil (B10) of the first branch (M1) and constituting a respective output out of nine outputs of the autotransformer, the second auxiliary coil (Y2) of the second given branch (M2) having a first terminal connected to the first intermediate power outlet (K′1) of the main coil (B10) of the first given branch and a second input or output terminal (B1) having a voltage phase-shifted by −20° with the voltage present on the second terminal (K′″1) of the main coil (B10) of the first branch (M1) and constituting another respective output out of nine outputs of the autotransformer.

3. The autotransformer as claimed in claim 2, wherein the main coil (B10) of each branch (M1) comprises a third intermediate power outlet (K1) and in that the autotransformer may be supplied either by the second intermediate power outlet (K″1) or by the third intermediate power outlet (K1) or else by the second terminal (K′″1) of each main coil (B10).

4. The autotransformer as claimed in claim 3, wherein the three-phase input voltages are applied either between the third intermediate power outlets (K″1, K″2, K″3) or between the first intermediate power outlets (K1, K2, K3) and in that the first three output voltages are delivered on the second terminals (K′″1, K′″2, K′″3) of each main coil (B10, B20, B30).

5. The autotransformer as claimed in claim 3, wherein the three-phase input voltages are applied either between the second terminals (K′″1, K′″2, K′″3) or between the third intermediate power outlets (K1, K2, K3) of the three main coils (B10, B20, B30) and the first three output voltages are delivered on the second intermediate power outlets (K″1, K″2, K″3) of each main coil (B10, B20, B30).

6. The autotransformer as claimed in claim 1, wherein the autotransformer comprises a magnetic core with three branches (M1, M2, M3) and on each magnetic branch a main coil (B12) having a first terminal (E1) and a second terminal (E2), the three main coils (B12, B23, B31) being electrically connected together in a triangle, in that it also comprises, on each magnetic branch (M1), five auxiliary coils (P12, Q12, R12, S12, T12), in that the autotransformer is designed to be supplied by the terminals (E1, E2, E3) of the main coils (B12, B23, B31),
for each branch, a first terminal of the first auxiliary coil (P12) of the first branch is connected to the first terminal (E1) of the main coil of the branch in question, and an intermediate point of the first auxiliary coil (P12) is connected to a first terminal of a third auxiliary coil (R31) of the third branch, the second terminal of the third auxiliary coil (R31) forming the point at which the first output voltage (C1) is available,
the second terminal of the first auxiliary coil (P12) is connected to a first terminal of the second auxiliary coil (Q23) of the second branch, the second terminal of the second auxiliary coil (Q23) of the second branch forming the point at which the second output voltage (A1) is available,
a first terminal of the fourth auxiliary coil (S31) of the third branch is connected to the first terminal (E1) of the main coil of the branch in question, the second terminal of the fourth auxiliary coil (S31) of the third branch is connected to a first terminal of the fifth auxiliary coil (T23) of the second branch, the second terminal of the fifth auxiliary coil (T23) of the second branch forming the point at which the third output voltage (B1) is available.

7. The autotransformer as claimed in claim 6, wherein it may be supplied either by the terminals (E1, E2, E3) of the main coils (B12, B23, B31) or by intermediate points (I1, I2, I3) of the main coils (B12, B23, B31).

8. The autotransformer as claimed in claim 1, wherein the autotransformer comprises a magnetic core with three branches (M1, M2, M3) and on each magnetic branch a main coil (B12) having a first terminal (E1) and a second terminal (E2), the three main coils (B12, B23, B31) being electrically connected together in a triangle, in that it also comprises, on each magnetic branch (M1), three auxiliary coils (X12, Y12, Z12), the main coil (B12) comprises three intermediate power outlets (J1, J″1, J′″1), in that the autotransformer is designed to be supplied by the terminals (E1, E2, E3) of the main coils (B12, B23, B31),
for each branch, a first terminal of the third auxiliary coil (Z12) of the first branch is connected to the third intermediate power outlet (J′″3) of the third branch, the second terminal of the third auxiliary coil (Z12) of the first branch forming the point at which the first output voltage (C1) is available,
a first terminal of the first auxiliary coil (X23) of the second branch is connected to the second intermediate power outlet (J″3) of the third branch, the second terminal of the first auxiliary coil (X23) of the second branch forming the point at which the second output voltage (A1) is available,
a first terminal of the second auxiliary coil (Y23) of the second branch is connected to the first intermediate power outlet (J1) of the first branch, the second terminal of the second auxiliary coil (Y23) of the second branch forming the point at which the third output voltage (B1) is available.

9. The autotransformer as claimed in claim 8, wherein the autotransformer supplied either by the terminals (E1, E2, E3) of the main coils (B12, B23, B31) or by the fourth intermediate power outlets (J′1, J′2, J′3) of the main coils (B12, B23, B31).

10. Alternating/continuous voltage converter, comprising an autotransformer as claimed in claim 1 and a triple-bridge diode rectifier (P1, P2, P3) receiving the output voltages from the autotransformer.
